(19) United States
(12) Patent Application Publication
(10) Pub. No.: US 2016/0026366 A1
(43) Pub. Date: Jan. 28, 2016

(54) METHOD AND SYSTEM FOR CUSTOMIZING MOBILE TERMINAL APPLICATION

(71) Applicant: Runfeng LUAN, Beijing (CN)

(72) Inventor: Runfeng LUAN, Beijing (CN)

(21) Appl. No.: 14/337,249

(22) Filed: Jul. 22, 2014

(51) Int. Cl. G06F 3/0484; G06F 9/445; H04L 29/08; H04L 29/06; G06F 17/24; G06F 3/0482

(52) U.S. Cl. CPC G06F 3/04842; G06F 17/248; G06F 3/0482; H04L 67/10; H04L 67/42; G06F 8/61

(57) ABSTRACT

The invention discloses a method and system for customizing a mobile terminal application, comprising: providing in advance several types of application templates in an application generation platform; when a certain type of application template is selected by a user, displaying initially by the application generation platform according to the application template selected by the user; configuring the resource information in the application template, and transferring the configured resource information to a first and a second server of different service types respectively, wherein the first server and second server convert the configured resource information into characteristic files which are compatible with the type of server and correspond with the type of the selected application template, copy the selected application template, analyze the characteristic file that corresponds with the type of application template.

### CROSS-REFERENCE TO RELATED APPLICATION

This application claims the priority benefit of Chinese patent application No.201410332510.9, filed Jul. 11, 2014. The entirety of the above-mentioned patent application is hereby incorporated by reference herein and made a part of specification.

### BACKGROUND OF THE INVENTION

1. Field of the Invention

The invention relates to the field of software application, and particularly to a method and system for customizing a mobile terminal application.

2. Background of the Invention

A mobile application (App) refers to an application which can run on a smart phone, tablet PC, and other mobile devices, e.g., applications in an Android operating system, and applications in an IOS operating system. The development of an application is a professional matter. Instead of an ordinary developer, only a professional developer is qualified for developing an application. In addition, such developing generally is time consuming. As the Android operating system and IOS operating system are becoming popular, more and more applications have been developed which are applicable to the Android operating system and IOS operating system, thus providing more and more options for mobile terminals. However, the current applications for mobile terminals have primarily been developed by the developer, so that an end-user has to passively accept the data information like functional definitions as provided by the developer, e.g. in an application of an educational type, or e-book. In such a mode, different demands of users of mobile terminals can not be met. In other words, the current Android and IOS applications are generated by the professional developers and are provided for downloading to users of mobile terminals, which makes it difficult to meet demands of different users.

### BRIEF SUMMARY OF THE INVENTION

In order to overcome defects in the prior art, the invention develops a method and system for customizing a mobile terminal application. It is an object of the invention to provide a method and system for enabling a user to customize a mobile application according to his demand to produce an application of his own. It is another object of the invention to provide a method and system for packaging in parallel which can produce two applications compatible with different platforms, thus producing an APK application and an IPA application at the same time. The method and system has a wide range of application, making it possible to freely customize an Android and IOS mobile application which meets the demand for personalization.

The technical solutions of the invention provides lie in the following aspects.

A method for customizing a mobile terminal application comprises:

providing in advance several types of application templates in an application generation platform;

when a certain type of application template is selected by a user, displaying initially by the application generation platform according to the application template selected by the user;

configuring the resource information in the application template, and transferring the configured resource information to a first and a second server of different service types respectively, wherein the first server and second server convert the configured resource information into characteristic files which are compatible with the type of server and correspond with the type of the selected application template, copy the selected application template, analyze the characteristic file that corresponds with the type of application template, and replace one by one the copied default resource information in the selected application template with the resource information configured by the user;

executing a packaging command by the first and second server to package the application template the default resource information of which has been replaced for forming a personalized application, and uploading the packaged application to a shared memory for downloading and installing.

Preferably, in the method for customizing a mobile terminal application, the first server is an Android server for APK package processing, and the second server is an IOS server for IPA package processing.

Preferably, in the method for customizing a mobile terminal application, when the configured resource information is delivered to the first server, replacing default values in an APK packaged characteristic file which corresponds to the selected type of application template with the configured resource information, thus forming a characteristic file compatible with Android service; and when the configured resource information is delivered to the second server, replacing default values in IOS packaged JSON file which corresponds to the selected type of application template with the configured resource information, thus forming a characteristic file compatible with IOS service.

Preferably, in the method for customizing a mobile terminal application, as for the first server, the characteristic file has a format of XML.

Preferably, in the method for customizing a mobile terminal application, as for the second server, the characteristic file has a format of JSON.

Preferably, in the method for customizing a mobile terminal application, the second server comprises two server components of a Tomcat server component and an Objective-c server component, wherein the Tomcat server component makes a response to the application generation platform upon receiving the resource information configured by user, and transfers a packaging command to the Objective-c server component for making the Objective-c server component to perform package processing.

Preferably, in the method for customizing a mobile terminal application, during packaging the application template the default resource information of which has been replaced, the process performed by the first server comprises compiling and packaging, while the process performed by the second server only comprises packaging.

Preferably, in the method for customizing a mobile terminal application, the resource information comprises application information, a start-up logo, or an interface skin.

Preferably, in the method for customizing a mobile terminal application, the application information comprises an application name, an application icon, or an application description.

Preferably, in the method for customizing a mobile terminal application, said several types of application templates comprise an image-text type and a video type, and the image-text type refers to e-books and periodicals, travel, sports, education, medical, government affairs, media, or health care.

A system for customizing a mobile terminal application comprises:

an application generation platform, wherein several types of application templates are provided in the application generation platform in advance, and when a certain type of application template is selected by a user, the application generation platform initially displays according to the application template selected by the user;

an information configuring unit for configuring the resource information in the application template, and transferring the configured resource information to a first and a second server of different service types respectively;

a package processing system, which is provided in the first and second server and is compatible with the service type respectively, wherein the first server and second server convert the configured resource information into characteristic files which are compatible with the type of server and correspond with the type of the selected application template, copy the selected application template, analyze the characteristic file that corresponds with the type of application template, replace one by one the copied default resource information in the selected application template with the resource information configured by the user, and excute a packaging command to package the application template the default resource information of which has been replaced for forming a personalized application; and

a shared memory, to which the first and second server upload the packaged application for the user to download and install.

Preferably, in the system for customizing a mobile terminal application, the first server is an Android server for APK package processing, and the second server is an IOS server for IPA package processing.

Preferably, in the system for customizing a mobile terminal application, when the configured resource information is delivered to the first server, default values in an APK packaged characteristic file which corresponds to the selected type of application template are replaced with the configured resource information, thus forming a characteristic file compatible with Android service; and when the configured resource information is delivered to the second server, default values in IOS packaged JSON file which corresponds to the selected type of application template are replaced with the configured resource information, thus forming a characteristic file compatible with IOS service.

Preferably, in the system for customizing a mobile terminal application, as for the first server, the characteristic file has a format of XML.

Preferably, in the system for customizing a mobile terminal application, as for the second server, the characteristic file has a format of JSON.

Preferably, in the system for customizing a mobile terminal application, the second server comprises two server components of a Tomcat server component and an Objective-c server component, wherein the Tomcat server component makes a response to the application generation platform upon receiving the resource information configured by user, and transfers a packaging command to the Objective-c server component for making the Objective-c server component to perform package processing.

Preferably, in the system for customizing a mobile terminal application, when the package processing module packages the application template the default resource information of which has been replaced, the process performed by the package processing module in the first server comprises compiling and packaging, while the process performed by the package processing module in the second server only comprises packaging.

Preferably, in the system for customizing a mobile terminal application, the resource information comprises application information, a start-up logo, or an interface skin.

Preferably, in the system for customizing a mobile terminal application, the application information comprises an application name, an application icon, or an application description.

Preferably, in the system for customizing a mobile terminal application, said several types of application templates comprise an image-text type and a video type, and the image-text type refers to e-books and periodicals, travel, sports, education, medical, government affairs, media, or health care.

The invention provides a method and system for customizing a mobile terminal application. In one aspect of the invention, the application template, as compared with the prior art, the application template which are provided in advance are retrieved, and the default information in the application template is replaced with the information resource configured by the user. An application can be produced by compile and packaging. In this manner, steps like program designing, program coding, simulation test, which are most time consuming and costly can be omitted, so that the user can customize a personalized application at will according to his preference. In another aspect of the invention, a technique for packaging in parallel is provided which can produce two different applications at the same time. With this technique, it is possible to obtain an APK application and an IPA application simultaneously. Besides, during producing the IPA application, the step of compiling is performed only once, which saves a lot of time. It is firstly required to copy the application template selected by the user during producing the application, and then the copied application template is packaged. In this way, the application templates which are provided in advance will not be damaged. When several users are customizing at the same a type of application, they will not influence each other, thus improving the work efficiency.

### BRIEF DESCRIPTION OF THE DRAWING(S)

FIG. 1 is a flowchart illustrating a method for customizing a mobile terminal application in the invention.

### DETAILED DESCRIPTION OF THE EMBODIMENTS

The invention will be described in detail hereinafter by referring to its embodiments, so that the skilled in the art can implement the invention in accordance with the present disclosure.

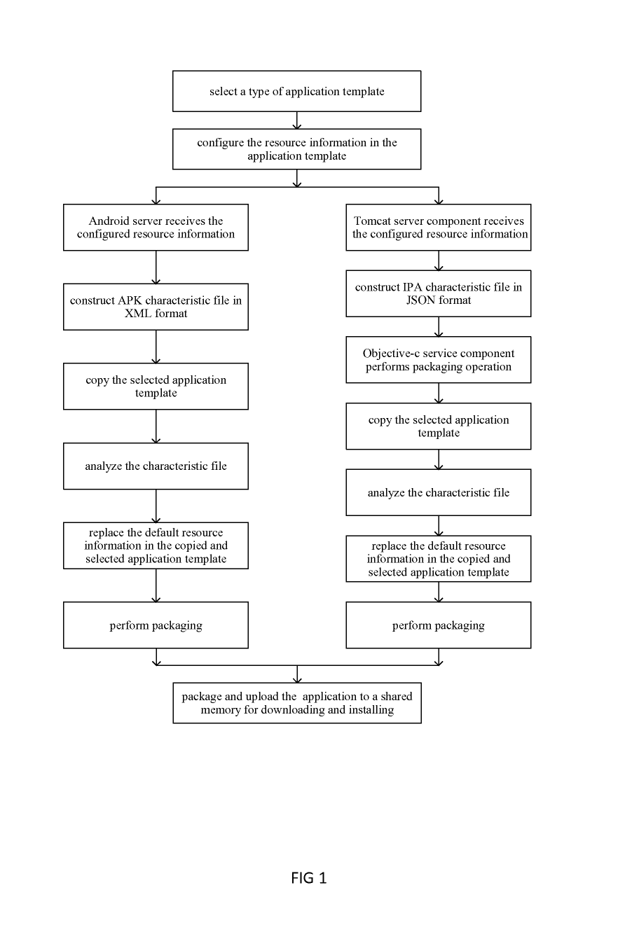

As shown in FIG. 1, the invention provides a method for customizing a mobile terminal application. The method comprises:

providing in advance several types of application templates in an application generation platform, wherein several types of application templates comprise an image-text type and an audio-video type, the image-text type relates to fields like e-books and periodicals, travel, sports, education, medical, government affairs, media, or health care, and the audio-video type relates to fields like listening to jokes, stories, lessons, books, comic dialogue, English, and wherein the desired application templates for any field that a user can imagine can be found in the application generation platform;

when a certain type of application template is selected by the user, the application generation platform displays initially according to the application template selected by the user, wherein at this time the user can configure the resource information in the application template according to his own preference, wherein the resource information that can be configured by the user comprises application information, a start-up logo, or an interface skin, wherein the application information comprises an application name, an application icon, or an application description, wherein the start-up logo or the interface skin can adopt a default picture, the picture provided by the application generation platform, or a picture which is uploaded by the user, wherein after the resource information is configured, the application generation platform delivers the resource information configured by the user to a first and second server of different service types, and wherein the first server is an Android server for APK package processing and the second server is an IOS server for IPA package processing.

After the first server receives the resource information configured by the user, the first server converts the configured resource information into a characteristic file of Android service which corresponds to the type of the selected application template. This process is explained as follow. The Android server system is provided in advance with a characteristic file which corresponds to the type of application template. After receiving the resource information configured by the user, the Android server replaces default values in the characteristic file corresponding to the type of application template with the resource information configured by the user, thus forming a characteristic file compatible with Android service. The characteristic file has a format of XML. Then a packaging operation is performed. Firstly, the selected application template is copied, the characteristic file corresponding to the type of application template is analyzed, and the copied default resource information in the selected application template is replaced one by one with the resource information configured by the user. A packaging command is executed to package the application template the default resource information of which has been replaced for forming a personalized application, and the packaged application is uploaded to a shared memory for downloading and installing. The user can download the application file from the shared memory through a file server.

The APK characteristic file has the following format:

```
  <?xml version=“1.0” encoding=“utf-8”?>
  <TemplateConfig Bin=“bin\bin-packages\News.1.360.V3.2.1\JinHer.News.apk”>
      <Files>
      <File FileName=“Icon36” ArmPath=“res\drawable-ldpi\icon.png”/>
      <File FileName=“Icon48” ArmPath=“res\drawable-mdpi\icon.png”/>
      <File FileName=“IosIcon57”
          ArmPath=“res\drawable-hdpi\shareicon.png”/>
      <File FileName=“Icon72” ArmPath=“res\drawable-hdpi\icon.png”/>
      <File FileName=“Icon96” ArmPath=“res\drawable-xhdpi\icon.png”/>
      <File FileName=“StartPic1”
      ArmPath=“res\drawable-hdpi\activity_loading_first.png”/>
      </Files>
      <TwoDimCodes>
      <TwoDimCode SavePath=“res\drawable\share_qrcode.png”/>
      </TwoDimCodes>
    <!--notes: in the configuration content, apart from the field to be designed, the character of
    “{” should not be contained, wherein the ternary values follow: ==, !=-->
  <ConfigInfo>
    <Config Path=“res\values\enterprise.xml” FileType=“xml”>
    <Item Node=“string[@name=‘app_name’]”
        NodeType=“Node”
        ReceivMode=“InnerText”
        Value=“{BacAppDTO>Name}”
    />
      <Item Node=“string[@name=‘down_text’]”
        NodeType=“Node” ReceivMode=“InnerText”
        Value=“scan the above two-dimensional code, append {BacAppDTO>Name}”
      />
    <Item Node=“string[@name=‘qrCode’]”
        NodeType=“Node”
        ReceivMode=“InnerText” Value=“{BacAppDTO>Name}two-dimensional code”
      />
    <Item Node=“string[@name=‘settingtitle’]”
      NodeType=“Node”
      ReceivMode=“InnerText”
      Value=“{BacAppDTO>Name}”
    />
    <Item Node=“string[@name=‘platform’]”
      NodeType=“Node”
      ReceivMode=“InnerText” Value=“{BacAppDTO>Name}”
    />
    <Item Node=“string[@name=‘share_news’]”
      NodeType=“Node”
      ReceivMode=“InnerText”
      Value=“share#{BacAppDTO>Name}#”
      />
      <Item Node=“string[@name=‘share_at’]”
        NodeType=“Node”
        ReceivMode=“InnerText”
        Value=“”
      />
    <Item Node=“string[@name=‘enterpriseId’]”
        NodeType=“Node”
        ReceivMode=“InnerText” Value=“{BacAppDTO>AppOwnerType==‘0’?”:
        BacAppDTO>OrgId}”
      />
    <Item Node=“string[@name=‘newsfeedbackhinttxt’]”
        NodeType=“Node” ReceivMode=“InnerText”
        Value=“Please input the title, contact person, and phone number of the unit or
  organization who applies to use {BacAppDTO>Name} platform. We will contact you ASAP,
  and thank you for your support.”
      />
    <Item Node=“string[@name=‘newsfeedback’]”
        NodeType=“Node” ReceivMode=“InnerText”
        Value=“apply to use {BacAppDTO>Name} platform”
      />
  </Config>
    <Config Path=“assets\defaultNewsId.xml” FileType=“xml”>
    <Item Node=“note[@id=‘newsId’]”
        NodeType=“Node”
        ReceivMode=“Attribute”
        ReceivAttributeName=“value” Value=“{BacAppDTO>Id}”
      />
    <Item Node=“note[@id=‘newsName’]”
          NodeType=“Node”
          ReceivMode=“Attribute”
          ReceivAttributeName=“value”
          Value=“{BacAppDTO>Name}”
        />
  </Config>
    <Config Path=“assets\appId.xml” FileType=“xml” EditMethod=“Set”>
    <Item Node=“note[@id=‘orgId’]”
          NodeType=“Node”
          ReceivMode=“Attribute”
          ReceivAttributeName=“value”
          Value=“{BacAppDTO>SubId}”
      />
    <Item Node=“note[@id=‘appId’]”
          NodeType=“Node”
          ReceivMode=“Attribute”
          ReceivAttributeName=“value”
          Value=“{BacAppDTO>Id}”
      />
    <Item Node=“note[@id=‘appPackageId’]”
          NodeType=“Node”
          ReceivMode=“Attribute”
          ReceivAttributeName=“value”
          Value=“{BacAppDTO>PackageId}”
      />
    <Item Node=“note[@id=‘accessToken’]”
          NodeType=“Node”
          ReceivMode=“Attribute”
          ReceivAttributeName=“value”
          Value=“{BacAppDTO>AccessToken}”
        />
    <Item Node=“note[@id=‘refreshToken’]”
          NodeType=“Node”
          ReceivMode=“Attribute”
          ReceivAttributeName=“value”
    Value=“{BacAppDTO>RefreshToken}”
      />
    <Item Node=“note[@id=‘defaultThemeId’]”
          NodeType=“Node”
          ReceivMode=“Attribute”
        ReceivAttributeName=“value”
        Value=“{BacAppDTO>SkinPicType}”
        />
  </Config>
    <Config Path=“assets\shareAppId.xml”
          FileType=“xml” EditMethod=“Set”
      >
    <Item Node=“note[@id=‘wxAppId’]”
          NodeType=“Node”
          ReceivMode=“Attribute”
          ReceivAttributeName=“value”
    Value=“{BacAppDTO>WeiXin}”
        />
    <Item Node=“note[@id=‘qqAppId’]”
          NodeType=“Node”
          ReceivMode=“Attribute”
          ReceivAttributeName=“value”
          Value=“{BacAppDTO>QQ}”
        />
    <Item Node=“note[@id=‘shareUrl’]”
          NodeType=“Node”
        ReceivMode=“Attribute”
            ReceivAttributeName=“value”
            Value=http:
            //bac.iuoooo.com/AppShare/Index?EnglishName={BacAppDTO>AppNo
          }
        />
    </Config>
    <Config Path=“AndroidManifest.xml”
          FileType=“xml” EditMethod=“Set”>
    <Item Node=“package”
          NodeType=“Root”
          ReceivMode=“Attribute”
            ReceivAttributeName=“value”
            Value=“com.jh.APP{BacAppDTO>AppNo}.news”
        />
      <Item Node=“android: versionCode”
          NodeType=“Root”
          ReceivMode=“Attribute”
          ReceivAttributeName=“value”
          Value=“{BacAppDTO>Version}”
        />
      <Item Node=“android: versionName”
          NodeType=“Root”
          ReceivMode=“Attribute”
            ReceivAttributeName=“value”
          Value=“{BacAppDTO>TemplateVersion}.{BacAppDTO>Version}”
      />
  </Config>
      <Config Path=“assets\table.xml”
          FileType=“xml”
          EditMethod=“CycleCreate”
          DataEntity=“AppModule”
        >
      <Item ParentNode=“root”
          PKAtr=“tabletype”
          Name=“note”
      InnerText=“{Name}”
          >
      <Attr AttrName=“order” Value=“{Sort}”/>
    <Attr AttrName=“tabletype” Value=“{ModuleType}”/>
    <Attr AttrName=“value” Value=“{ModuleUrl}”/>
    <Attr AttrName=“bgorder” Value=“{Icon}”/>
    </Item>
    </Config>
    </ConfigInfo>
    </TemplateConfig>
```

After receiving the resource information configured by the user, the second server converts the configured resource information into a characteristic file of IOS service which corresponds to the type of the selected application template. This process is explained as follow. Default values in the IOS packaged JSON file which corresponds to the type of application template selected by user are replaced with the configured resource information, thus forming a characteristic file compatible with IOS service. The characteristic file has a format of JSON. Then a packaging operation is performed. Firstly, the selected application template is copied, the characteristic file corresponding to the type of application template is analyzed, and the copied default resource information in the selected application template is replaced one by one with the resource information configured by the user. A packaging command is executed to package the application template the default resource information of which has been replaced for forming a personalized application, and the packaged application is uploaded to a shared memory for downloading and installing. The second server comprises two server components of a Tomcat server component and an Objective-c server component, wherein the Tomcat server component makes a response to the application generation platform upon receiving the resource information configured by user, and transfers a packaging command to the Objective-c server component for making the Objective-c server component to perform package processing. The user can download the application file from the shared memory through a file server.

The IPA characteristic file has the following format:

```
    { “appId”: “661b1a27-4555-470c-bc22-d595929188e0”,
    “projectName”: “JinherNews.app”,
    “replacePlist”: [ { “plistName”: “Info.plist”,
    “values”: { “APPID”: “661b1a27-4555-470c-bc22-d595929188e0”,
    “CFBundleDisplayName”: “eee33”,
                “CFBundleIdentifier”:
                “com.jinher.app.661b1a27-4555-470c-bc22-d595929188e0”,
    “CFBundleShortVersionString”: “4”,
    “ColumnName”: “Interact”,
    “PACKID”: “ecf88261-1ca3-4687-9502-9a3111277b17”,
    “SUBID”: “815754d6-0957-4f4c-8ff2-730c77cac7fc”
    }
    } ],
    “replaceResources”: [ { “bak”: “IndustryTemplate54/StartPic/1ios1.png”,
    “name”: “Default@2x.png”,
    “subImages”: [ ],
```

| | |
|---|---|
| “url”: | “http: |

```
//prefileserver.iuoooo.com/Jinher.JAP.BaseApp.FileServer.UI/FileManage/GetFile?fileURL=29e
54e46-3e17-4ca4-8f03-db71fb8f9651/ImgFCreateAPP/f993da5e-305d-4d1a-9acb-a8abf428582
2_ec152ba6-a89f-4ba5-8dbd-532ba62ad3e2.png”
    },
    { “bak”: “IndustryTemplate54/StartPic/1ios2.png”,
    “name”: “Default-568h@2x.png”,
    “subImages”: [ ],
```

| | |
|---|---|
| “url”: | “http: |

```
//prefileserver.iuoooo.com/Jinher.JAP.BaseApp.FileServer.UI/FileManage/GetFile?fileURL=29e
54e46-3e17-4ca4-8f03-db71fb8f9651/ImgFCreateAPP/84e0e278-ff2c-412b-a87c-ed0d16eb913
1_5fc86ae3-6ff5-4a5c-b8c5-487395eb3209.png”
    },
    { “bak”: “IndustryTemplateIcon/54.png”,
    “name”: “”,
    “subImages”: [ { “height”: 120,
    “name”: “icon-120.png”,
    “width”: 120
    },
    { “height”: 114,
    “name”: “icon-114.png”,
    “width”: 114
    }
    ],
```

| | |
|---|---|
| “url”: | “http: |

```
//prefileserver.iuoooo.com/Jinher.JAP.BaseApp.FileServer.UI/FileManage/GetFile?fileURL=29
E54E46-3E17-4CA4-8F03-DB71FB8F965A/Img/a3de2092-b2fa-4860-ae0f-23cd097a43fa_512.
png”
    }
    ]
    }
```

In the method for customizing a mobile terminal application, during packaging the application template the default resource information of which has been replaced, the process performed by the first server comprises compiling and packaging, while the process performed by the second server only comprises packaging, namely, compiling is performed for only one time. When the Objective-c server component performs the packaging operation, the application template which corresponds to the type selected by the user is copied and decompressed. The characteristic file which corresponds to the type of application template is analyzed. The default resource information in the copied application template is replaced with the resource information configured by the user, and is compressed to form an installable APK application file. In this process, there is no need for compiling, which significantly reduces the packaging time. While the Android server performs APK package processing, in which it is required to recompile and package so as to form an installable APK application file.

Thus, an application template is provided in the application generation platform, which can produce an APK application and an IPA application simultaneously for the user to download and install.

A system for customizing a mobile terminal application comprises:

an application generation platform, wherein several types of application templates are provided in the application generation platform in advance, and when a certain type of application template is selected by a user, the application generation platform initially displays according to the application template selected by the user;

an information configuring unit for configuring the resource information in the application template, and transferring the configured resource information to a first and a second server of different service types respectively;

a package processing system, which is provided in the first and second server and is compatible with the service type respectively, wherein the first server and second server convert the configured resource information into characteristic files which are compatible with the type of server and correspond with the type of the selected application template, copy the selected application template, analyze the characteristic file that corresponds with the type of application template, replace one by one the copied default resource information in the selected application template with the resource information configured by the user, and excute a packaging command to package the application template the default resource information of which has been replaced for forming a personalized application; and

a shared memory, to which the first and second server upload the packaged application for the user to download and install.

In the system for customizing a mobile terminal application, the first server is an Android server for APK package processing, and the second server is an IOS server for IPA package processing.

In the system for customizing a mobile terminal application, when the configured resource information is delivered to the first server, default values in an APK packaged characteristic file which corresponds to the selected type of application template are replaced with the configured resource information, thus forming a characteristic file compatible with Android service; and when the configured resource information is delivered to the second server, default values in IOS packaged JSON file which corresponds to the selected type of application template are replaced with the configured resource information, thus forming a characteristic file compatible with IOS service.

In the system for customizing a mobile terminal application, as for the first server, the characteristic file has a format of XML.

In the system for customizing a mobile terminal application, as for the second server, the characteristic file has a format of JSON.

In the system for customizing a mobile terminal application, the second server comprises two server components of a Tomcat server component and an Objective-c server component, wherein the Tomcat server component makes a response to the application generation platform upon receiving the resource information configured by user, and transfers a packaging command to the Objective-c server component for making the Objective-c server component to perform package processing.

In the system for customizing a mobile terminal application, when the package processing module packages the application template the default resource information of which has been replaced, the process performed by the package processing module in the first server comprises compiling and packaging, while the process performed by the package processing module in the second server only comprises packaging.

In the system for customizing a mobile terminal application, the resource information comprises application information, a start-up logo, or an interface skin.

In the system for customizing a mobile terminal application, the application information comprises an application name, an application icon, or an application description.

In the system for customizing a mobile terminal application, said several types of application templates comprise an image-text type and a video type, and the image-text type refers to e-books and periodicals, travel, sports, education, medical, government affairs, media, or health care.

Although the invention has been described above with reference to specific embodiments, it should be understood that the limitations of the described embodiments are merely for illustrative purpose and by no means limiting. Instead, the scope of the invention is defined by the appended claims rather than by the description, and all variations that fall within the range of the claims are intended to be embraced therein. Thus, other embodiments than the specific ones described above are equally possible within the scope of these appended claims.

What is claimed is:

1. A method for customizing a mobile terminal application, characterized by comprising:
providing in advance several types of application templates in an application generation platform;
when a certain type of application template is selected by a user, displaying initially by the application generation platform according to the application template selected by the user;
configuring the resource information in the application template, and transferring the configured resource information to a first and a second server of different service types respectively, wherein the first server and second server convert the configured resource information into characteristic files which are compatible with the type of server and correspond with the type of the selected application template, copy the selected application template, analyze the characteristic file that corresponds with the type of application template, and replace one by one the copied default resource information in the selected application template with the resource information configured by the user; and
executing a packaging command by the first and second server to package the application template the default resource information of which has been replaced for forming a personalized application, and uploading the packaged application to a shared memory for downloading and installing.

2. The method of claim 1, characterized in that, the first server is an Android server for APK package processing, and the second server is an IOS server for IPA package processing.

3. The method of claim 2, characterized in that,
when the configured resource information is delivered to the first server, replacing default values in an APK packaged characteristic file which corresponds to the selected type of application template with the configured resource information, thus forming a characteristic file compatible with Android service; and
when the configured resource information is delivered to the second server, replacing default values in IOS packaged JSON file which corresponds to the selected type of application template with the configured resource information, thus forming a characteristic file compatible with IOS service.

4. The method of claim 3, characterized in that, as for the first server, the characteristic file has a format of XML.

5. The method of claim 4, characterized in that, as for the second server, the characteristic file has a format of JSON.

6. The method of claim 5, characterized in that, the second server comprises two server components of a Tomcat server component and an Objective-c server component, wherein the Tomcat server component makes a response to the application generation platform upon receiving the resource information configured by user, and transfers a packaging command to the Objective-c server component for making the Objective-c server component to perform package processing.

7. The method of claim 6, characterized in that, during packaging the application template the default resource information of which has been replaced, the process performed by the first server comprises compiling and packaging, while the process performed by the second server only comprises packaging.

8. The method of claim 7, characterized in that, the resource information comprises application information, a start-up logo, or an interface skin.

9. The method of claim 8, characterized in that, the application information comprises an application name, an application icon, or an application description.

10. The method of claim 9, characterized in that, said several types of application templates comprise an image-text type and a video type, and the image-text type refers to e-books and periodicals, travel, sports, education, medical, government affairs, media, or health care.

11. A system for customizing a mobile terminal application, characterized by comprising:
an application generation platform, wherein several types of application templates are provided in the application generation platform in advance, and when a certain type of application template is selected by a user, the application generation platform initially displays according to the application template selected by the user;
an information configuring unit for configuring the resource information in the application template, and transferring the configured resource information to a first and a second server of different service types respectively;
a package processing system, which is provided in the first and second server and is compatible with the service type respectively, wherein the first server and second server convert the configured resource information into characteristic files which are compatible with the type of server and correspond with the type of the selected application template, copy the selected application template, analyze the characteristic file that corresponds with the type of application template, replace one by one the copied default resource information in the selected application template with the resource information configured by the user, and excute a packaging command to package the application template the default resource information of which has been replaced for forming a personalized application; and
a shared memory, to which the first and second server upload the packaged application for the user to download and install.

12. The system of claim 11, characterized in that, the first server is an Android server for APK package processing, and the second server is an IOS server for IPA package processing.

13. The system of claim 12, characterized in that,
when the configured resource information is delivered to the first server, default values in an APK packaged characteristic file which corresponds to the selected type of application template are replaced with the configured resource information, thus forming a characteristic file compatible with Android service; and
when the configured resource information is delivered to the second server, default values in IOS packaged JSON file which corresponds to the selected type of application template are replaced with the configured resource information, thus forming a characteristic file compatible with IOS service.

14. The system of claim 13, characterized in that, as for the first server, the characteristic file has a format of XML.

15. The system of claim 14, characterized in that, as for the second server, the characteristic file has a format of JSON.

16. The system of claim 15, characterized in that, the second server comprises two server components of a Tomcat server component and an Objective-c server component, wherein the Tomcat server component makes a response to the application generation platform upon receiving the resource information configured by user, and transfers a packaging command to the Objective-c server component for making the Objective-c server component to perform package processing.

17. The system of claim 16, characterized in that, when the package processing module packages the application template the default resource information of which has been replaced, the process performed by the package processing module in the first server comprises compiling and packaging, while the process performed by the package processing module in the second server only comprises packaging.

18. The system of claim 17, characterized in that, the resource information comprises application information, a start-up logo, or an interface skin.

19. The system of claim 18, characterized in that, the application information comprises an application name, an application icon, or an application description.

20. The system of claim 19, characterized in that, said several types of application templates comprise an image-text type and a video type, and the image-text type refers to e-books and periodicals, travel, sports, education, medical, government affairs, media, or health care.
